(19) United States
(12) Patent Application Publication
(10) Pub. No.: US 2026/0251750 A1
(43) Pub. Date: Aug. 27, 2026

(54) ELECTRONIC WARFARE SYSTEM AND METHOD

(71) Applicant: ELBIT SYSTEMS EW AND SIGINT-ELISRA LTD., Holon (IL)

(72) Inventors: Assaf GAVRA, Holon (IL); Henry Victor ALUSH, Holon (IL); Oren AVRAHAM, Holon (IL); Ovadia DVIR DABACH, Holon (IL)

(21) Appl. No.: 19/284,774

(22) Filed: Jul. 30, 2025

Related U.S. Application Data
(63) Continuation of application No. PCT/IL2024/050002, filed on Jan. 1, 2024.

(30) Foreign Application Priority Data
Feb. 22, 2023 (IL) 300929

(51) Int. Cl. G01S 7/02; H04B 1/69

(52) U.S. Cl. CPC G01S 7/021; H04B 1/69

(57) ABSTRACT

The presently disclosed subject matter aims for an electronic warfare system including: (i) a Radar Warning Receiver (RWR) configured to receive: (a) at least one first signal being a radar emission signal emitted by a respective radar-based system in a first frequency spectrum, and (b) at least one second signal being a non-radar emission signal in a second frequency spectrum; and, (ii) a processing circuitry, being in communication with the RWR, configured to: obtain from the receiver the at least one first and second signals; analyze the at least one first signal and the at least one second signal to determine a set of characteristics associated with each of the signals; and upon the set of characteristics of at least one signal of the signals meeting a respective predefined set of characteristics, perform an action.

### TECHNICAL FIELD

The present invention relates to the field of electronic warfare systems and methods.

### BACKGROUND

Electronic warfare is any action involving the strategic use of the electromagnetic spectrum, or of tactics related thereof, against an adversary in a military conflict (e.g., while attacking the adversary, while impeding adversary assaults, etc.). Electronic warfare may be applied from air, sea, land, and/or space, by crewed and/or uncrewed systems, and may target communication, radar, or other military and civilian assets.

Traditionally, electronic warfare is separated into three major subdivisions: (i) electronic attack (EA), (ii) electronic protection (EP), and (iii) electronic support(ES). The electronic support(ES) subdivision involves operations aimed at detecting, intercepting, identifying, locating, and/or localizing sources of intended and unintended radiated electromagnetic energy. The goal is to provide immediate recognition, prioritization, and targeting of threats.

A Radar warning receiver (RWR) system is a relatively straightforward example of an ES system, directed to detect the radio emissions of radar systems and issue a warning when a radar signal, potentially threatening a platform on which the RWR is mounted, is detected. The RWR system typically consists of multiple wideband antennas placed around said platform, enabling the receiver to periodically scan across the frequency band and determine various parameters of the received signals (e.g., signal frequency, shape, direction of arrival, pulse repetition frequency, etc.).

Despite the widespread use of RWR systems and their operational efficiency, these systems are restricted to detecting radio emissions of radar systems only, therefore requiring the installation of additional ES systems on said platform to enable the detection of other types of signals. Using several systems on the same platform may encounter practical difficulties, especially in situations where the platform on which said systems are mounted is limited in terms of its ability to house a large number of systems, as well as create awkwardness and difficulty in simultaneously operating said systems, which may affect their proper operation.

Thus, there is a need in the art for a new electronic warfare system and method.

### GENERAL DESCRIPTION

In accordance with a first aspect of the presently disclosed subject matter, there is provided an airborne electronic warfare system mounted on an aerial platform, the airborne electronic warfare system comprising: a Radar Warning Receiver (RWR) configured to receive: (a) at least one first signal being a radar emission signal emitted by a respective radar-based system in a first frequency spectrum, and (b) at least one second signal being a non-radar emission signal in a second frequency spectrum; and, a processing circuitry, being in communication with the receiver, configured to: obtain from the receiver the at least one first and second signals; analyze the at least one first signal and the at least one second signal to determine a set of characteristics associated with each of the signals; and upon the set of characteristics of at least one signal of the signals meeting a respective predefined set of characteristics, perform an action.

In some cases, (i) the airborne electronic warfare system is operative according to a mission regime composed of a plurality of missions arranged according to their order of execution, (ii) each mission of the missions is associated with an allotted slot within a frequency spectrum, within which the mission is to be executed, and (iii) each mission of the missions is associated with the receiving of either a first signal or a second signal, such that the receiver does not receive both signal types simultaneously.

In some cases, the mission regime is a dynamic mission regime within which the frequency of execution of each of the plurality of missions is modified according to a flight stage or state of the aerial platform.

In some cases, the flight stage or state is one of: landing, takeoff, flight, hovering, taxiing, or standby.

In some cases, the mission regime is a dynamic mission regime within which the plurality of missions are arranged by priority.

In some cases, the priority is determined either (i) automatically, by the airborne electronic warfare system, (ii) manually, by a user of the airborne system, (iii) or a combination thereof.

In some cases, the first frequency spectrum and the second frequency spectrum are identical.

In some cases, (i) the RWR is an existing system, and (ii) the ability of the RWR to receive both the first and second signals is due to one or more upgrades to its firmware.

In some cases, (i) the airborne electronic warfare system includes one or more additional receivers, each configured to receive signals in a specific frequency spectrum, and (ii) the RWR and the one or more additional receivers are configured to operate simultaneously.

In some cases, the RWR is capable of (i) simultaneously receiving signals of different types associated with different frequency spectrums, and (ii) performing one or more missions associated with the signals simultaneously.

In some cases, the at least one second signal is a data communication signal transmitted along a communication channel extending between any two parties.

In some cases, the two parties are at least one unmanned vehicle and a controller directed to enable an operator to communicate with the at least one unmanned vehicle.

In some cases, the at least one unmanned vehicle is an aerial unmanned vehicle.

In some cases, the airborne electronic warfare system further includes a transmitter configured to transmit at least one counter signal, upon a match between the set of characteristics of the at least one signal and the respective predefined set of characteristics, such that the counter signal disrupts the operation of the at least one party of the parties.

In some cases, the communication signal is a spread-spectrum signal.

In some cases, the at least one second signal is converted to a pseudo-radar emission signal, such that the system relates to the at least one second signal as a received first signal.

In some cases, (i) the set of characteristics associated with the data communication signal includes a first subset of distinct characteristics associated with a first party of the parties and a second subset of distinct characteristics associated with a second party of the parties, and (ii) upon either the first subset of characteristics, the second subset of characteristics, or both, meeting the respective predefined set of characteristics, the system is capable of performing actions associated with either the first party, the second party, or both, independently.

In some cases, the at least one second signal is a beacon signal emitted from at least one emission device associated with at least one object to be located.

In some cases, the beacon signal includes a distinct identifier associated with the at least one emission device transmitting the signal.

In some cases, the at least one second signal is converted to a pseudo-radar emission signal, such that the system relates to the at least one second signal as a received first signal.

In some cases, the set of characteristics and the respective predefined set of characteristics include at least one of: range, power, frequency, transmission over time, frequency modulation, time modulation, or direction.

In some cases, the at least one first and second signals are received by the receiver through a matched filter.

In some cases, the action is one of: (i) alerting a user of the airborne electronic warfare system of an object associated with the at least one signal, (ii) providing the user of the system with a distance between the airborne electronic warfare system and the object, (iii) providing the user of the system with a direction to the object (iv) providing the user of the system with a movement direction of the object, (v) providing the user of the system with a type of the object, (vi) providing the user of the system with a communication type of the communication through which the object communicates, or any combination thereof.

In some cases, the aerial platform is a moving platform whose movement enables determining the location of the object based on triangulation.

In some cases, the triangulation is performed based on information received from a plurality of aerial platforms.

In some cases, the triangulation is performed based on information received from a plurality of stationary platforms.

In accordance with a second aspect of the presently disclosed subject matter, there is provided an electronic warfare method comprising: obtaining, by a processing circuitry, from a Radar Warning Receiver (RWR), (a) at least one first signal being a radar emission signal in a first frequency spectrum, and (b) at least one second signal being a non-radar emission signal in a second frequency spectrum; analyzing, by the processing circuitry, the at least one first signal and the at least one second signal to determine a set of characteristics associated with each of the signals; and upon the set of characteristics of at least one signal of the signals meeting a respective predefined set of characteristics, performing, by the processing circuitry, an action.

In some cases, (i) the method is operative according to a mission regime composed of a plurality of missions arranged according to their order of execution, (ii) each mission of the missions is associated with an allotted slot within a frequency spectrum, within which the mission is to be executed, and (iii) each mission of the missions is associated with the receiving of either a first signal or a second signal, such that the RWR does not receive both signal types simultaneously.

In some cases, the mission regime is a dynamic mission regime within which the frequency of execution of each of the plurality of missions is modified according to a flight stage or state of the aerial platform.

In some cases, the flight stage or state is one of: landing, takeoff, flight, hovering, taxiing, or standby.

In some cases, the mission regime is a dynamic mission regime within which the plurality of missions are arranged by priority.

In some cases, the priority is determined either (i) automatically, by the processing circuitry, (ii) manually, by a user of the method, (iii) or a combination thereof.

In some cases, the first frequency spectrum and the second frequency spectrum are identical.

In some cases, (i) the RWR is an existing system, and (ii) the ability of the RWR to receive both the first and second signals is due to one or more upgrades to its firmware.

In some cases, the RWR is capable of (i) simultaneously receiving signals of different types associated with different frequency spectrums, and (ii) performing one or more missions associated with the signals simultaneously.

In some cases, the at least one second signal is a data communication signal transmitted along a communication channel extending between any two parties.

In some cases, the two parties are at least one unmanned vehicle and a controller directed to enable an operator to communicate with the at least one unmanned vehicle.

In some cases, the at least one unmanned vehicle is an aerial unmanned vehicle.

In some cases, the communication signal is a spread-spectrum signal.

In some cases, the at least one second signal is converted to a pseudo-radar emission signal, such that the signal is considered a received first signal.

In some cases, the at least one second signal is a beacon signal emitted from at least one emission device associated with at least one object to be located.

In some cases, the beacon signal includes a distinct identifier associated with the at least one emission device transmitting the signal.

In some cases, the at least one second signal is converted to a pseudo-radar emission signal, such that the signal is considered a received first signal.

In some cases, the set of characteristics and the respective predefined set of characteristics include at least one of: range, power, frequency, transmission over time, frequency modulation, time modulation, or direction.

In some cases, the at least one first and second signals are received by the receiver through a matched filter.

In some cases, the action is one of: (i) alerting a user of an object associated with the at least one signal, (ii) providing the user with a distance between from the object, (iii) providing the user with a direction to the object (iv) providing the user with a movement direction of the object, (v) providing the user with a type of the object, (vi) providing the user with a communication type of the communication through which the object communicates, or any combination thereof.

In accordance with a third aspect of the presently disclosed subject matter, there is provided a non-transitory computer readable storage medium having computer readable program code embodied therewith, the computer readable program code, executable by at least one processor to perform an electronic warfare method, the method comprising: obtaining, by a processing circuitry, from a Radar Warning Receiver (RWR), (a) at least one first signal being a radar emission signal in a first frequency spectrum, and (b) at least one second signal being a non-radar emission signal in a second frequency spectrum; analyzing, by the processing circuitry, the at least one first signal and the at least one second signal to determine a set of characteristics associated with each of the signals; and upon the set of characteristics of at least one signal of the signals meeting a respective predefined set of characteristics, performing, by the processing circuitry, an action.

### BRIEF DESCRIPTION OF THE DRAWINGS

In order to understand the presently disclosed subject matter and to see how it may be carried out in practice, the subject matter will now be described, by way of non-limiting examples only, with reference to the accompanying drawings, in which:

FIG. 1 is a schematic illustration of an environment in which an electronic warfare system, in accordance with the presently disclosed subject matter, operates;

FIG. 2 is a block diagram schematically illustrating one example of components of an electronic warfare system, in accordance with the presently disclosed subject matter; and,

FIG. 3 is a flowchart illustrating an example of a sequence of operations carried out by an electronic warfare system, in accordance with the presently disclosed subject matter.

### DETAILED DESCRIPTION

In the following detailed description, numerous specific details are set forth in order to provide a thorough understanding of the presently disclosed subject matter. However, it will be understood by those skilled in the art that the presently disclosed subject matter may be practiced without these specific details. In other instances, well-known methods, procedures, and components have not been described in detail so as not to obscure the presently disclosed subject matter.

In the drawings and descriptions set forth, identical reference numerals indicate those components that are common to different embodiments or configurations.

Unless specifically stated otherwise, as apparent from the following discussions, it is appreciated that throughout the specification discussions utilizing terms such as “obtaining”, “analyzing”, “performing”, “operating”, “determining”, or the like, include action and/or processes of a computer that manipulate and/or transform data into other data, said data represented as physical quantities, e.g., such as electronic quantities, and/or said data representing the physical objects. The terms “computer”, “processor”, “processing resource”, “processing circuitry”, and “controller” should be expansively construed to cover any kind of electronic device with data processing capabilities, including, by way of non-limiting example, a personal desktop/laptop computer, a server, a computing system, a communication device, a smartphone, a tablet computer, a smart television, a processor (e.g. digital signal processor (DSP), a microcontroller, a field programmable gate array (FPGA), an application specific integrated circuit (ASIC), etc.), a group of multiple physical machines sharing performance of various tasks, virtual servers co-residing on a single physical machine, any other electronic computing device, and/or any combination thereof.

The operations in accordance with the teachings herein may be performed by a computer specially constructed for the desired purposes or by a general-purpose computer specially configured for the desired purpose by a computer program stored in a non-transitory computer readable storage medium. The term “non-transitory” is used herein to exclude transitory, propagating signals, but to otherwise include any volatile or non-volatile computer memory technology suitable to the application.

As used herein, the phrase “for example,” “such as”, “for instance” and variants thereof describe non-limiting embodiments of the presently disclosed subject matter. Reference in the specification to “one case”, “some cases”, “other cases” or variants thereof means that a particular feature, structure or characteristic described in connection with the embodiment(s) is included in a least one embodiment of the presently disclosed subject matter. Thus, the appearance of the phrase “one case”, “some cases”, “other cases” or variants thereof does not necessarily refer to the same embodiment(s).

It is appreciated that, unless specifically stated otherwise, certain features of the presently disclosed subject matter, which are, for clarity, described in the context of separate embodiments, may also be provided in combination in a single embodiment. Conversely, various features of the presently disclosed subject matter, which are, for brevity, described in the context of a single embodiment, may also be provided separately or in any suitable sub-combination.

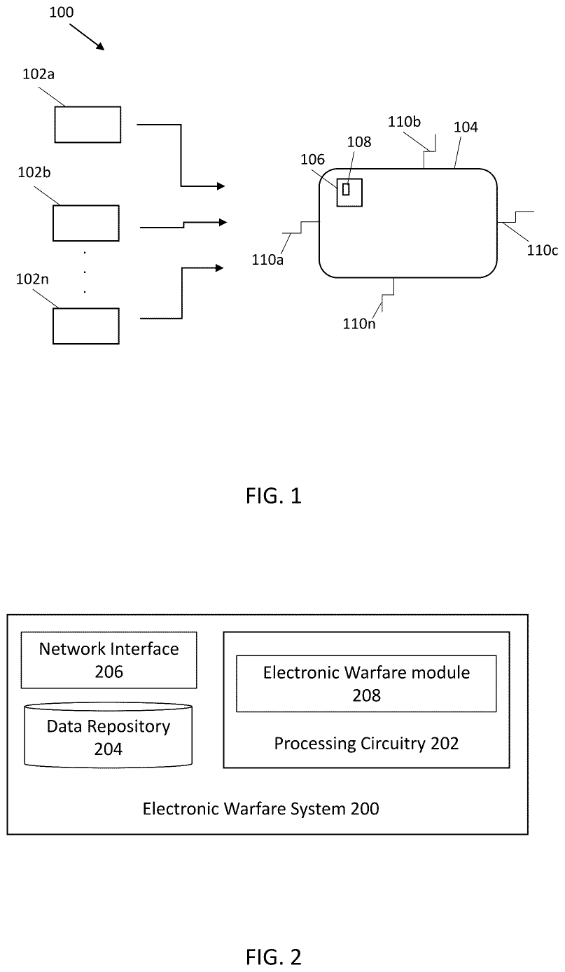

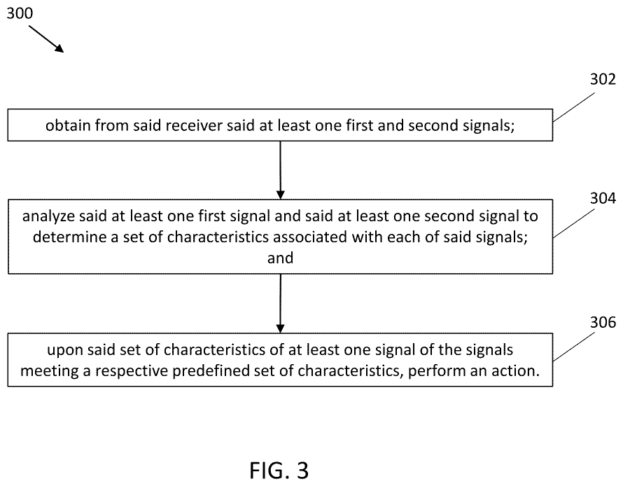

In embodiments of the presently disclosed subject matter, fewer, more and/or different stages than those shown in FIG. 3 may be executed. In embodiments of the presently disclosed subject matter one or more stages illustrated in FIG. 3 may be executed in a different order and/or one or more groups of stages may be executed simultaneously. FIG. 1 illustrate a general schematic of the system architecture in accordance with an embodiment of the presently disclosed subject matter. Each module in FIG. 2 may be made up of any combination of software, hardware and/or firmware that performs the functions as defined and explained herein. The modules in FIG. 2 may be centralized in one location or dispersed over more than one location. In other embodiments of the presently disclosed subject matter, the system may comprise fewer, more, and/or different modules than those shown in FIG. 2.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system should be applied mutatis mutandis to a method that may be executed by the system and should be applied mutatis mutandis to a non-transitory computer readable medium that stores instructions that may be executed by the system.

Any reference in the specification to a non-transitory computer readable medium should be applied mutatis mutandis to a system capable of executing the instructions stored in the non-transitory computer readable medium and should be applied mutatis mutandis to method that may be executed by a computer that reads the instructions stored in the non-transitory computer readable medium.

Bearing this in mind, attention is drawn to FIG. 1, showing a schematic illustration of an environment in which an electronic warfare system (also interchangeably referred to herein as “system”), in accordance with the presently disclosed subject matter, operates.

As shown in the schematic illustration, environment 100 includes one or more emitters, denoted 102a to 102n (n being an arbitrary number representing any possible integer number), dispersed therein, and a platform 104, either stationary or mobile.

Initially, attention is directed to the one or more emitters, 102a to 102n. Each emitter of said emitters may be located at a distinct location within environment 100 or travel along a trajectory such that it may move toward or away from said platform 104. In addition, each emitter may be directed to emit signals of a specific type and be related to an object (or be the object itself) associated with either an adversary, such that it may pose a threat to said platform 104, or a supporter, such that it does not pose any threat to said platform whatsoever. For example, emitters 102a to 102n, or a subset thereof, may be radar-based systems (such as air-defense systems, guided missile systems, and the like), or components thereof (e.g., a detection and tracking radar, a guided missile, etc.), directed to emit radar emission signals. Alternatively, emitters 102a to 102n, or a subset thereof, may be non-radar-based systems (such as search and rescue systems, Unmanned Aerial Vehicle (UAV) systems, and the like), or components thereof (e.g., a survivor device, a drone, etc.), directed to emit non-radar emission signals (for example, a communication signal (e.g., cellular, Wi-Fi, Bluetooth, satellite, etc.), a beacon signal, and the like).

Next, attention is directed to the platform 104. Platform 104 (for example, a moving platform such as an aerial platform (e.g., a plane, a helicopter, etc.), a ground platform (e.g., a vehicle, a vessel, etc.), and the like) may include (i) an electronic warfare system 106, mounted thereon, containing a Radar Warning Receiver (RWR) 108 (among other components that will be detailed hereinafter in relation to FIG. 2), and (ii) one or more antennas, denoted 110a to 110 (n being an arbitrary number representing any possible integer number), dispersed thereon. The one or more antennas, 110a to 110n, typically being wideband antennas though other types may also be applicable, may be directed to enable said RWR 108 to periodically or sporadically scan across the frequency band in search of emitted signals.

The RWR 108 may be configured to receive various types of emitted signals. In one example, RWR 108 may be configured to receive a first type of emitted signal, being a radar emission signal emitted by a respective radar-based system in a first frequency spectrum. In another example, alternatively or additionally to the above, the RWR 108 may be configured to receive a second type of emitted signal, being a non-radar emission signal (e.g., a communication signal, a beacon signal, and the like) emitted by a respective non-radar-based system in a second frequency spectrum.

In some cases, the frequency spectrums of both said types of emitted signals are identical, such that said RWR 108 may be configured to receive both said types of emitted signals simultaneously (optionally through a matched filter). In other cases, the frequency spectrums of both said types of emitted signals are unidentical, such said RWR 108 may be configured to receive each type of emitted signal separately (i.e., non-simultaneously).

The ability of RWR 108, and by virtue of being part of the electronic warfare system 106 also of said system, to receive various types of emitted signals (either simultaneously or non-simultaneously), as mentioned hereinbefore, may arise from one or more upgrades to its firmware. Alternatively, said ability of said electronic warfare system 106 may arise from the presence of additional receivers, being part of said system, such that each receiver, including RWR 108, may be configured to receive signals in a specific frequency spectrum and operate simultaneously or non-simultaneously with the other receivers.

During its operation, explained in further detail hereinafter in relation to FIG. 3, electronic warfare system 106 may operate according to a mission regime composed of a plurality of missions arranged according to their order of execution. Each mission of the plurality of missions may be associated with an allotted slot within a frequency spectrum, within which the mission is to be executed. In addition, each mission of said missions may be associated with receiving either a first signal, e.g., of the first type of emitted signal mentioned hereinbefore, or a second signal, e.g., of the second type of emitted signal mentioned hereinbefore. For example, a mission regime consisting of three missions intended to be performed by system 106, (i) a first mission related to receiving a first signal of the first type mentioned above, (ii) a second mission related to receiving a second signal of the second type mentioned above, and (iii) a third mission related to receiving a third signal of the second type mentioned above (different than the second type of the second signal), may be arranged along the electromagnetic spectrum such that each mission is distinctly associated with an allotted slot of the electromagnetic spectrum, correlating with the frequency of its respective signal (i.e., either the first, second, or third signal), and as such is executed by system 106 only within said slot.

The mission regime may be a dynamic mission regime within which the frequency of execution of each of its plurality of missions may be modified according to certain characteristics. In one example, the mission regime may be modified according to priority, determined, for example, either (i) automatically, by said electronic warfare system 106, (ii) manually, by a user of said electronic warfare system 106, or (iii) by a combination thereof. In another example, the mission regime may be modified according to a stage or state of the platform.

By way of example, correlating with the latter example above, the platform may be an aerial platform, and the mission regime may be modified according to one or more flight stages or states of the aerial platform (e.g., landing, takeoff, flight, hovering, taxiing, standby, etc.).

In accordance with the above in relation to RWR 108's ability to receive, simultaneously or not simultaneously, different types of emitted signals, it should be noted that said RWR 108 may perform two or more tasks of the mission regime simultaneously, or each of them separately.

Attention is now drawn to additional components of the electronic warfare system 106.

FIG. 2 is a block diagram schematically illustrating one example of the electronic warfare system 106, in accordance with the presently disclosed subject matter.

In accordance with the presently disclosed subject matter, the electronic warfare system 106 (also interchangeably referred to herein as “system 100”) may comprise a network interface 206. The network interface 206 (e.g., a network card, a Wi-Fi client, 3G/4G client, or any other component), enables system 106 to communicate over a network with external systems and handles inbound and outbound communications from such systems. For example, system 106 may receive, through network interface 206, a mission regime composed of a plurality of missions arranged according to their order of execution.

System 106 may further comprise or be otherwise associated with a data repository 204 (e.g., a database, a storage system, a memory including Read Only Memory—ROM, Random Access Memory—RAM, or any other type of memory, etc.) configured to store data. Some examples of data that may be stored in the data repository 204 include:
One or more first and/or second signals;
One or more first and/or second frequency spectrums;
One or more sets of characteristics of one or more first and/or second signals;
One or more predefined sets of characteristics;
One or more stages or states of the platform;
One or more mission regimes;
One or more firmware upgrades;
One or more performed or to be performed actions; etc.

Data repository 204 may be further configured to enable retrieval and/or update and/or deletion of the stored data. It is to be noted that in some cases, data repository 204 may be distributed, while the system 106 has access to the information stored thereon, e.g., via a wired or wireless network to which system 106 is able to connect (utilizing its network interface 206).

System 106 further comprises processing circuitry 202. Processing circuitry 202 may be one or more processing units (e.g., central processing units), microprocessors, microcontrollers (e.g., microcontroller units (MCUs)) or any other computing devices or modules, including multiple and/or parallel and/or distributed processing units, which are adapted to independently or cooperatively process data for controlling relevant system 100 resources and for enabling operations related to system's 106 resources.

The processing circuitry 202 comprises an electronic warfare module 208, configured to perform an electronic warfare process, as further detailed herein, inter alia with reference to FIG. 3.

Turning to FIG. 3 there is shown a flowchart illustrating one example of operations carried out by the electronic warfare system 106, in accordance with the presently disclosed subject matter.

Accordingly, the electronic warfare system 106 (also interchangeably referred to hereafter as “system 106”) may be configured to perform an electronic warfare process 300, e.g., using electronic warfare module 208.

For this purpose, system 106 obtains, from its RWR 108 component, at least one first signal, being a radar emission signal emitted by a respective radar-based system in a first frequency spectrum, and at least one second signal, being a non-radar emission signal in a second frequency spectrum (block 302). In one example, the at least one second signal may be a data communication signal (e.g., a spread-spectrum communication signal) transmitted along a communication channel (either directly or indirectly (e.g., by passing through several intermediate transmission points)) between a first party (for example, at least one unmanned aerial vehicle (e.g., a drone, an uncrewed aircraft, etc.), at least one unmanned ground vehicle (e.g., a military robot, etc.), at least one unmanned surface vehicle (e.g., a boat, etc.), at least one unmanned underwater vehicle (e.g., a submarine, etc.)) and a second party (e.g., a controller directed to enable an operator to communicate with said first party, etc.). In another example, the at least one second signal may be a beacon signal (optionally including a distinct identifier intended to distinguish said signal from other signals of the same or different type) emitted from at least one emission device associated with at least one object to be located (e.g., a survivor of a disaster event, a pilot who abandoned his aircraft for whatever reason, a shipment of some sort, etc.). In some cases, following its obtaining, the at least one second signal may be converted to a pseudo-radar emission signal, such that said system relates to it as a received first signal.

By way of a non-limiting example (presented merely for purposes of better understanding the disclosed subject matter and not in any way intended to limit its scope), system 106 obtains at least one radar emission signal emitted by a guided missile launched by an adversary toward an aerial platform on which said system is mounted, and at least one non-radar emission signal, a communication signal, transmitted along a communication channel between an adversary drone and its respective controller, controlled by the adversary drone's operator.

Once obtained, system 106 analyzes the at least one first signal and the at least one second signal to determine a set of characteristics associated with each of said signals (block 304). Upon the set of characteristics of at least one signal of the signals meeting a respective predefined set of characteristics, system 106 performs an action (block 306).

In relation to the aforementioned sets of characteristics, the respective predefined set of characteristics and the set of characteristics associated with each of said signals may include, for example, one or more of: range, power, frequency, pulse width, repetition, transmission over time, frequency modulation, time modulation, or direction. In addition, the set of characteristics associated with each signal of said signals may be utilized to determine other features associated with said signal, such as classification, and the like.

In relation to the action performed by system 106, said action may be, for example, one or more of: (i) alerting a user of said airborne electronic warfare system of an object associated with said at least one signal, (ii) providing the user of said system with a distance between said airborne electronic warfare system and said object, (iii) providing the user of said system with a direction to said object (iv) providing the user of said system with a movement direction of said object, (v) providing the user of said system with a type of said object, (vi) providing the user of said system with a communication type of the communication through which said object communicates, to name a few.

In accordance with our non-limiting example, system 106 analyzes the at least one radar emission signal emitted by the launched guided missile and the at least one communication signal emitted from the adversary drone to its operator and determines range, power, frequency, pulse width, repetition, and direction for each. System 106 then compares the characteristics of each of said signals to a predetermined set of characteristics of range, power, frequency, pulse width, repetition, and direction, and given that only the set of characteristics associated with the launched guided missile matches the predetermined set of characteristics, the system 106 alerts the user of the launched missile.

In cases where the at least one second signal is a communication signal, said set of characteristics associated with said data communication signal may include (i) a first subset of distinct characteristics associated with a first party of the parties involved is said communication, and (ii) a second subset of distinct characteristics associated with a second party of said the parties involved in said communication. In such cases, upon either said first subset of characteristics, said second subset of characteristics, or both, meeting said respective predefined set of characteristics, the system 106 may be capable of performing actions associated with either of them or both, independently. For example, system 106 may further include a transmitter configured to transmit at least one counter signal, upon a match between said set of characteristics of said at least one signal and said respective predefined set of characteristics, such that said counter signal disrupts the operation of at least one of said parties.

In cases where the performed action involves determining the location of an object, the location may be determined, for example, based on triangulation. In one example, system 106 may be mounted on a moving aerial platform such that said triangulation may be performed based on information received from a plurality of aerial platforms found around said moving aerial platform. In another example, system 106, mounted on said moving aerial platform, may perform said triangulation based on information received from a plurality of stationary platforms found around said moving aerial platform.

It is to be noted, with reference to FIG. 3, that some of the blocks may be integrated into a consolidated block or may be broken down to a few blocks and/or other blocks may be added. It is to be further noted that some of the blocks are optional. It should be also noted that whilst the flow diagram is described also with reference to the system elements that realizes them, this is by no means binding, and the blocks may be performed by elements other than those described herein.

It is to be understood that the presently disclosed subject matter is not limited in its application to the details set forth in the description contained herein or illustrated in the drawings. The presently disclosed subject matter is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the present presently disclosed subject matter.

It will also be understood that the system according to the presently disclosed subject matter may be implemented, at least partly, as a suitably programmed computer. Likewise, the presently disclosed subject matter contemplates a computer program being readable by a computer for executing the disclosed method. The presently disclosed subject matter further contemplates a machine-readable memory tangibly embodying a program of instructions executable by the machine for executing the disclosed method.

1. An airborne electronic warfare system mounted on an aerial platform, the airborne
electronic warfare system comprising:
a Radar Warning Receiver (RWR) configured to receive: (a) at least one first signal being a radar emission signal emitted by a respective radar-based system in a first frequency spectrum, and (b) at least one second signal being a non-radar emission signal in a second frequency spectrum; and,
a processing circuitry, being in communication with said receiver, configured to:
obtain from said receiver said at least one first and second signals;
analyze said at least one first signal and said at least one second signal to determine a set of characteristics associated with each of said signals; and
upon said set of characteristics of at least one signal of the signals meeting a respective predefined set of characteristics, perform an action.

2. The airborne electronic warfare system of claim 1, wherein (i) said airborne electronic warfare system is operative according to a mission regime composed of a plurality of missions arranged according to their order of execution, (ii) each mission of said missions is associated with an allotted slot within a frequency spectrum, within which the mission is to be executed, and (iii) each mission of said missions is associated with the receiving of either a first signal or a second signal, such that said receiver does not receive both signal types simultaneously.

3. The airborne electronic warfare system of claim 1, wherein (i) said RWR is an existing system, and (ii) the ability of said RWR to receive both said first and second signals is due to one or more upgrades to its firmware.

4. The airborne electronic warfare system of claim 1, wherein (i) said airborne electronic warfare system includes one or more additional receivers, each configured to receive signals in a specific frequency spectrum, and (ii) said RWR and said one or more additional receivers are configured to operate simultaneously.

5. The airborne electronic warfare system of claim 1, wherein said RWR is capable of (i) simultaneously receiving signals of different types associated with different frequency spectrums, and (ii) performing one or more missions associated with said signals simultaneously.

6. The airborne electronic warfare system of claim 1, wherein said at least one second signal is a data communication signal transmitted along a communication channel extending between any two parties.

7. The airborne electronic warfare system of claim 6, wherein said two parties are at least one unmanned vehicle and a controller directed to enable an operator to communicate with said at least one unmanned vehicle.

8. The airborne electronic warfare system of claim 6, wherein said airborne electronic warfare system further includes a transmitter configured to transmit at least one counter signal, upon a match between said set of characteristics of said at least one signal and said respective predefined set of characteristics, such that said counter signal disrupts the operation of said at least one party of said parties.

9. The airborne electronic warfare system of claim 6, wherein said communication signal is a spread-spectrum signal.

10. The airborne electronic warfare system of claim 6, wherein (i) said set of characteristics associated with said data communication signal includes a first subset of distinct characteristics associated with a first party of said parties and a second subset of distinct characteristics associated with a second party of said parties, and (ii) upon either said first subset of characteristics, said second subset of characteristics, or both, meeting said respective predefined set of characteristics, said system is capable of performing actions associated with either said first party, said second party, or both, independently.

11. The airborne electronic warfare system of claim 1, wherein said at least one second signal is a beacon signal emitted from at least one emission device associated with at least one object to be located.

12. An electronic warfare method comprising:
obtaining, by a processing circuitry, from a Radar Warning Receiver (RWR), (a) at least one first signal being a radar emission signal in a first frequency spectrum, and (b) at least one second signal being a non-radar emission signal in a second frequency spectrum;
analyzing, by said processing circuitry, said at least one first signal and said at least one second signal to determine a set of characteristics associated with each of said signals; and
upon said set of characteristics of at least one signal of the signals meeting a respective predefined set of characteristics, performing, by said processing circuitry, an action.

13. The electronic warfare method of claim 12, wherein (i) said method is operative according to a mission regime composed of a plurality of missions arranged according to their order of execution, (ii) each mission of said missions is associated with an allotted slot within a frequency spectrum, within which the mission is to be executed, and (iii) each mission of said missions is associated with the receiving of either a first signal or a second signal, such that said RWR does not receive both signal types simultaneously.

14. The electronic warfare method of claim 12, wherein (i) said RWR is an existing system, and (ii) the ability of said RWR to receive both said first and second signals is due to one or more upgrades to its firmware.

15. The electronic warfare method of claim 12, wherein said RWR is capable of (i) simultaneously receiving signals of different types associated with different frequency spectrums, and (ii) performing one or more missions associated with said signals simultaneously.

16. The electronic warfare method of claim 12, wherein said at least one second signal is a data communication signal transmitted along a communication channel extending between any two parties.

17. The electronic warfare method of claim 16, wherein said two parties are at least one unmanned vehicle and a controller directed to enable an operator to communicate with said at least one unmanned vehicle.

18. The electronic warfare method of claim 16, wherein said communication signal is a spread-spectrum signal.

19. The electronic warfare method of claim 12, wherein said at least one second signal is a beacon signal emitted from at least one emission device associated with at least one object to be located.

20. A non-transitory computer readable storage medium having computer readable program code embodied therewith, the computer readable program code, executable by at least one processor to perform an electronic warfare method, the method comprising:
obtaining, by a processing circuitry, from a Radar Warning Receiver (RWR), (a) at least one first signal being a radar emission signal in a first frequency spectrum, and (b) at least one second signal being a non-radar emission signal in a second frequency spectrum;
analyzing, by said processing circuitry, said at least one first signal and said at least one second signal to determine a set of characteristics associated with each of said signals; and
upon said set of characteristics of at least one signal of the signals meeting a respective predefined set of characteristics, performing, by said processing circuitry, an action.
